(19) United States
(12) Patent Application Publication
(10) Pub. No.: US 2007/0195246 A1
(43) Pub. Date: Aug. 23, 2007

(54) MVA LCD

(76) Inventor: Chun-Yi Huang, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/423,147

(22) Filed: Jun. 9, 2006

(30) Foreign Application Priority Data
Feb. 23, 2006 (TW) 095106139

(51) Int. Cl. G02F 1/1337

(52) U.S. Cl. 349/129

(57) ABSTRACT

An alignment protrusions disposition is in a multi domain vertical alignment (MVA) liquid crystal display (LCD). It includes a plurality of pixel units in the MVA LCD. Each of the pixel units has a plurality of alignment protrusions, and the alignment protrusions have a plurality of different included angles. The MVA LCD has more than two kinds of alignment protrusions in one of the pixel units, and the pre-tilt angles of the liquid crystals in each of the pixel units have more than eight directions of domain.

### BACKGROUND OF THE INVENTION

1. Field of the Invention

The present invention relates to an MVA LCD, and more particularly, to an MVA LCD having more than two kinds of alignment protrusions in one pixel unit.

2. Description of the Prior Art

LCDs are applied in various electrical products, such as cell phones, PDAs, and notebooks. Large size displays have been quickly developed, resulting in thin and light LCDs largely replacing CRTs in the market. However, the visual angle of LCDs is not sufficiently wide to ensure high display quality, therefore limiting the development of LCDs. A multi-domain vertical alignment (MVA) display is therefore made to increase the visual angle.

The MVA LCD has a protrusion and a slit on both a common electrode and a pixel electrode respectively. A liquid crystal in each pixel unit has a pre-tilt angle before a potential difference is applied across the pixel unit. Please refer to FIG. 1. FIG. 1 is a diagram showing the pre-tilt angle of the liquid crystal in an MVA LCD According to the prior art. In the prior art, each of the pixel units 10 of an MVA LCD has one kind of alignment protrusion 12 formed on a common electrode (not shown) similar to the structure of V. A slit 14 is formed on a pixel electrode (not shown) also having a V shape. The pre-tilt angles of the liquid crystals have four kinds of directions of domain 16, 18, 20, 22.

When the MVA LCD of the prior art is used, however, a color shift occurs, particularly if a user looks at the monitor squarely then sideways on. The picture of the MVA LCD will become pale due to the light leak. The Gamma Curve of the MVA LCD in the prior art shifts by a large amount when the visual angle is bigger, so the gray level becomes lower, and the picture becomes pale.

The prior arts detail different distances between an alignment protrusion and an adjacent alignment protrusion, causing corresponding threshold voltages to be different in order to obtain a better voltage-transmittance characteristic curve. The objectives of these patents are to decrease the difference between the voltage-transmittance characteristic curves of the front view and the sideways view. The shift of the Gamma curve of the MVA LCD also improves, therefore the picture does not pale, and the user is able to look at the monitor sideways on. The display effect is improved.

### SUMMARY OF THE INVENTION

The present invention provides an alignment protrusions disposition in an MVA LCD to solve the above-mentioned problem.

An embodiment of the present invention provides an alignment protrusions disposition is in a multi domain vertical alignment liquid crystal display. It includes a plurality of pixel units in the multi domain vertical alignment liquid crystal display. Each of the pixel units has a plurality of alignment protrusions, and the alignment protrusions have a plurality of different angles.

The MVA LCD of the present invention has more than two kinds of alignment protrusions in one pixel unit. The pre-tilt angles of the liquid crystals in each of the pixel units have eight directions of domain. The transmittance of the MVA LCD therefore increases. When a user looks at the MVA LCD and the visual angle is increased, the transmittance differences of each visual angle decrease, so the picture will not pale when the user looks at it sideways on. The overall display effect is thereby improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of the pre-tilt angle of the liquid crystal in an MVA LCD according to the prior art.

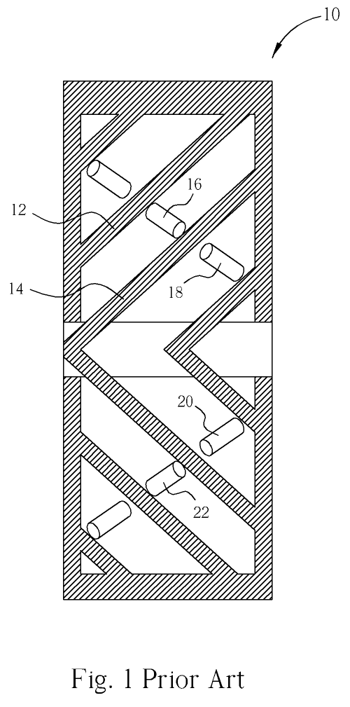

FIG. 2 is a diagram of the pixel unit structure according to the present invention.

FIG. 3 is a diagram of the alignment protrusion disposition according to the present invention.

FIG. 4 is a diagram of the alignment protrusion height, width and angle according to the present invention.

FIG. 5 is a diagram of another alignment protrusion disposition according to the present invention.

FIG. 6 is a voltage-transmittance characteristic curve of the pixel unit according to the present invention.

### DETAILED DESCRIPTION

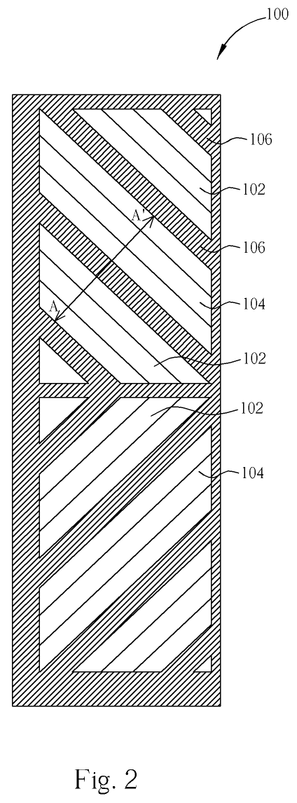

Please refer to FIG. 2. FIG. 2 is a diagram of the pixel unit structure according to the present invention. An MVA LCD (not shown) has a plurality of pixel units 100. In this embodiment, a common electrode (not shown) of the pixel unit 100 has two kinds of alignment protrusions 102, and 104. The alignment protrusions 102, 104 are formed in the pixel unit 100, each having a V shape. Furthermore, a pixel electrode (not shown) of the pixel unit 100 has a plurality of slits 106, which are formed in the pixel unit 100, each having a V shape. As can be seen from FIG. 2, which is a top view of the pixel unit 100, the alignment protrusions 102, 104, and the slit 106 are formed in the pixel unit 100 with a V shape, each parallel to each other and not overlapping.

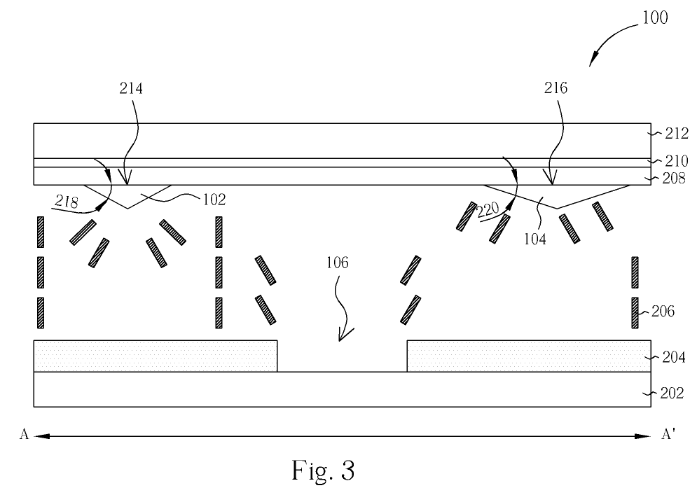

Please refer to FIG. 3. FIG. 3 is a diagram of the alignment protrusion disposition according to the present invention. FIG. 3 is a cross section view along AA′ in FIG. 2. A liquid crystal 206 is between an upper glass panel 212 and a lower glass panel 202 of the pixel unit 100 in FIG. 3. The lower glass panel 202A covers the pixel electrode 204. The slit 106 is formed in the pixel electrode 104. Furthermore, a color filter 210, and a common electrode 208 are sequentially layered below the upper glass panel 212, and the alignment protrusions 102, 104 are formed on the common electrode 208. Although the heights of the alignment protrusions 102, 104 are the same in this embodiment, the width 214 of the alignment protrusion 102 is smaller than the width 216 of the alignment protrusion 104. This means the alignment protrusion angle 218 of the alignment protrusion 102 is bigger than the alignment protrusion angle 220 of the alignment protrusion 104.

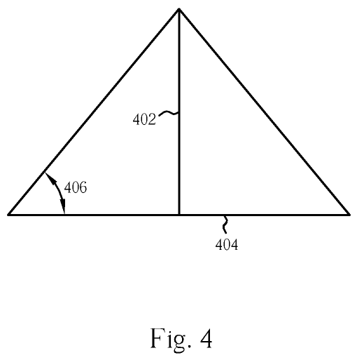

In the other words, each of the pixel units has a plurality of alignment protrusions having different angles is the characteristic of the present invention. Please refer to Table 1. Table 1 shows the relation between the alignment protrusion height, width and angle. Table 1 can be utilized in correspondence with FIG. 4. FIG. 4 is a diagram of the alignment protrusion height, width and angle according to the present invention. An alignment protrusion height 402, and width 404 can be changed according to the data of Table 1, changing the angle 406.

TABLE 1

| | | | | | |
|---|---|---|---|---|---|
| Alignment protrusion | 1.5/10 | 1.5/15 | 1.5/20 | 1.9/10 | 1.9/15 |
| height/width(μm/μm) | | | | | |
| Alignment protrusion | 17 | 11 | 9 | 21 | 14 |
| angle(°) | | | | | |

As FIG. 3 shows, the heights of two kinds of alignment protrusions 102, 104 are the same in this embodiment. If we want to change the alignment protrusion angle 218, 220, the following data can be referred to:

(1) If the heights of the alignment protrusions 102, 104 are 1.5 μm, the width 214 of the alignment protrusion 102 is 10 μm, the width 216 of the alignment protrusion 104 is 15 μm, and the angle 218 is 17°, the angle 220 is 11°.

(2) If the heights of the alignment protrusion 102, 104 are 1.5 μm, the width 214 of the alignment protrusion 102 is 15 μm, the width 216 of the alignment protrusion 104 is 20 μm, and the angle 218 is 11°, the angle 220 is 9°.

(3) If the heights of the alignment protrusion 102, 104 are 1.5 μm, the width 214 of the alignment protrusion 102 is 10 μm, the width 216 of the alignment protrusion 104 is 20 μm, and the angle 218 is 17°, the angle 220 is 9°.

(4) If the heights of the alignment protrusion 102, 104 are 1.9 μm, the width 214 of the alignment protrusion 102 is 10 μm, the width 216 of the alignment protrusion 104 is 15 μm, and the angle 218 is 21°, the angle 220 is 14°.

Of course, when the heights of the alignment protrusions 102, 104 are the same, the width 216 is bigger than width 214, and the angle 220 is smaller than the angle 218. The variations between the alignment protrusion height and width are not limited to the above-mentioned variations, and can be altered by the user.

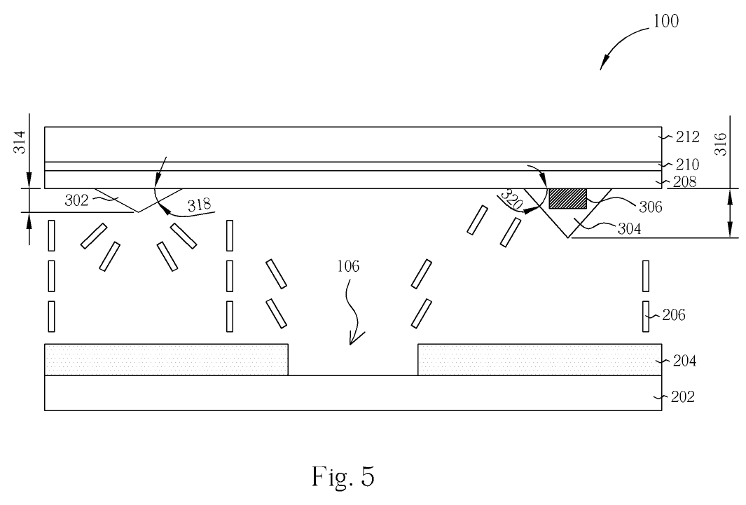

Please refer to FIG. 5. FIG. 5 is a diagram of another alignment protrusion disposition according to the present invention. FIG. 5 is similar to FIG. 3, but the alignment protrusions 102, 104 in FIG. 3 are changed to the alignment protrusions 302, 304 of FIG. 5. The alignment protrusions 302, 304 of FIG. 5 are made by the same PEP, and the widths of the alignment protrusions 302, 304 are the same. The alignment protrusion 304 is made on a pad 306, however, so the height 316 is higher than the height 302. Therefore, the angle 318 of the alignment protrusion 302 is smaller than the angle 320 of the alignment protrusion 304. The pad 306 can be made by a black matrix or varied color resin like a color filter.

In this embodiment, the widths of the two kinds of alignment protrusions 302, 304 are the same. The heights 314, 316 are made different by the inclusion of the pad 306, however, making the angles 318, 320 different. Please refer to the following data for variety. Of course, the relation between the pad height and the alignment protrusion width is not limited to the following figures, and can be altered by the user.

(1) The height of the pad 306 is 0.4 μm, and the widths of the alignment protrusions 302, 304 are 10 μm. If the height 314 of the alignment protrusion 302 is 1.5 μm, and the angle 318 is 17°. The alignment protrusion 304 has the pad 306 in itself, so the height 316 is 1.9 μm, and the angle 320 is 21°.

(2) The height of the pad 306 is still 0.4 μm, and the widths of the alignment protrusions 302, 304 are 15 μm. If the height 314 of the alignment protrusion 302 is 1.5 μm, and the angle 318 is 11°. The alignment protrusion 304 has the pad 306 in itself, so the height 316 is 1.9 μm, and the angle 320 is 14°.

In both FIG. 3 and FIG. 5, each of the pixel units has two kinds of alignment protrusion having different angles. The liquid crystal 206 is filled between the alignment protrusion 102, 104 and the slit 106 has eight kinds of pre-tilt angles. Referring to FIG. 3, the liquid crystal 206 in the two sides of alignment protrusion 102 has two kinds of pre-tilt angles. As there are two kinds of alignment protrusions 102, 104, there are four kinds of pre-tilt angles. The alignment protrusions 102, 104 are formed on the common electrode 208 with a V shape. So, the liquid crystal 206 in the upper part of the V shape is 90 degrees different from the liquid crystal 206 in the lower part of the V shape. The two kinds of the alignment protrusions 102, 104 in one pixel unit 100 make eight directions of domain of the liquid crystal 206 pre-tilt angles. The liquid crystals 206 compensate each other, and alignment protrusions 102, 104, and 302, 304 in FIG. 3 and FIG. 5 respectively can all be made by the same photo mask, so the manufacture is simple. If manufacture permits, several photo masks can be made with different heights, but equal width alignment protrusion.

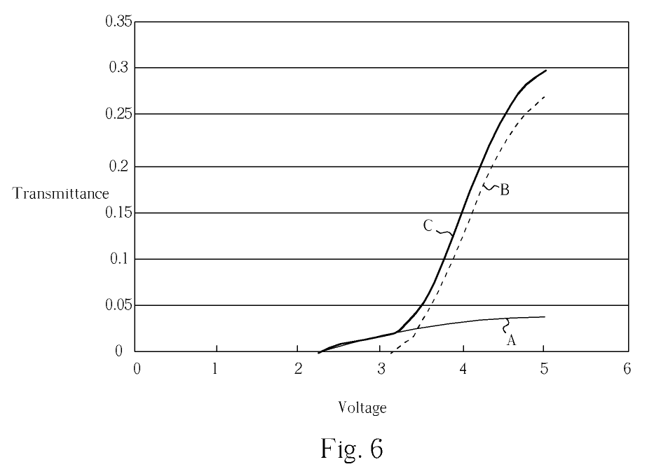

Please refer to FIG. 6. FIG. 6 is a voltage-transmittance characteristic curve of the pixel unit according to the present invention. There are three curves A, B, and C in FIG. 6. Curve A presents the voltage-transmittance characteristic curve by using one alignment protrusion. Curve B presents the voltage-transmittance characteristic curve by using the other alignment protrusion. Curve C presents the voltage-transmittance characteristic curve by using two alignment protrusions of curves A, and B. When curves A, B, and C all have the same voltage, curve C has the highest transmittance. In other words, the pixel unit has two kinds of alignment protrusion, and the transmittance increases. As the transmittance increases, when the users look at an MVA LCD and the visual angle is increased, the transmittance differences of each visual angle decrease. The Gamma curve shift of MVA LCD improves, and the picture will not pale when the users look at it sideways on. The overall display effect is improved.

Please note that the present invention does not only have two kinds of alignment protrusions in each of the pixel units. It can be a regular or irregular disposition, such as the regular disposition of two first alignment protrusions having first angle and one second alignment protrusion having second angle. And more than two kinds of alignment protrusions in each of the pixel units can be utilized to increase the pre-tilt angles of the liquid crystal. The angle of the alignment protrusion is not only changed by changing the width and height of the alignment protrusion, as mentioned above, but can also be changed by another method that makes more than two kinds of alignment protrusion in one pixel unit.

The MVA LCD of the present invention has more than two kinds of alignment protrusions in one pixel unit. The pre-tilt angles of the liquid crystals in each of the pixel units have eight directions of domain. The transmittance of MVA LCD increases. When the users look at an MVA LCD and the visual angle is increased, the transmittance differences of each visual angle decrease. The picture will not pale when the users look at it sideways on. The overall display effect is thereby improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A MVA LCD, comprising:
a plurality of pixel units, wherein each of the pixel units of the unit having a plurality of alignment protrusions, wherein the alignment protrusions having different sizes of a plurality of alignment protrusion angles.

2. The MVA LCD of claim 1, wherein the MVA LCD further comprises:
an upper glass panel;
a lower glass panel;
a liquid crystal layer between the upper, and lower glass panels; and
a common electrode formed between the upper glass panel and the liquid crystals.

3. The MVA LCD of claim 2, wherein each of the pixel units comprises:
a TFT formed on the lower glass panel;
a pixel electrode formed on the lower glass panel and electrical connected to the TFT; and
a color filter formed between the common electrode and the upper glass panel.

4. The MVA LCD of claim 3, wherein the alignment protrusions are between the upper glass panel and the liquid crystal layer.

5. The MVA LCD of claim 3, wherein the pixel electrode has a plurality of slits, and each of the slits is respectively between the alignment protrusions and the adjacent alignment protrusion.

6. The MVA LCD of claim 3, wherein the alignment protrusions and slits in each of the pixel units have formed a V shape.

7. The MVA LCD of claim 1, wherein the alignment protrusions have the same heights, but have different widths, and different alignment protrusions angles.

8. The MVA LCD of claim 1, wherein the alignment protrusions have the same widths, but have different heights, and different alignment protrusions angles.

9. The MVA LCD of claim 1, wherein a part of the alignment protrusions have a pad inside each of the alignment protrusions.

10. The MVA LCD of claim 9, wherein the pad is a black matrix.

11. The MVA LCD of claim 9, wherein the pad is a color filter.

12. A MVA LCD comprising:
a first substrate and a second substrate;
a common electrode installed on the first substrate;
a liquid crystal layer between the first substrate and the second substrate;
a plurality of electrodes installed on the second substrate to define a plurality of pixel units; and
a first alignment protrusion and a second alignment protrusion being parallel to the second substrate in each of the pixel units, and the first alignment protrusion is apart from the second alignment protrusion.

13. The MVA LCD of claim 12, wherein the electrodes are respectively apart by a slit.

14. The MVA LCD of claim 13, wherein the slit formed a V shape.

15. The MVA LCD of claim 12, wherein the first alignment protrusion and the second alignment protrusion have different sizes.

16. The MVA LCD of claim 12, wherein the first alignment protrusion and the second alignment protrusion have different heights.

17. The MVA LCD of claim 12, wherein the first alignment protrusion and the second alignment protrusion have different widths.

18. The MVA LCD of claim 12, wherein the MVA LCD further comprises a pad, and the pad is disposed in one of the first alignment protrusion and the second alignment protrusion.

19. The MVA LCD of claim 18, wherein the pad is a black matrix.

20. The MVA LCD of claim 18, wherein the pad is a color filter.
